(19) United States
(12) Patent Application Publication
(10) Pub. No.: US 2016/0355258 A1
(43) Pub. Date: Dec. 8, 2016

(54) Aerial Fluid Delivery System

(71) Applicant: Vadient Optics, LLC., Beaverton, OR (US)

(72) Inventors: George Williams, Portland, OR (US); David Barsic, Portland, OR (US)

(73) Assignee: Vadient Optics, LLC., Beaverton, OR (US)

(21) Appl. No.: 14/732,989

(22) Filed: Jun. 8, 2015

(51) Int. Cl. B64C 39/02; B05B 13/00; B05B 15/06

(52) U.S. Cl. CPC B64C 39/024; B05B 15/061; B05B 13/005; B64C 2201/128

(57) ABSTRACT

An aerial fluid delivery system comprises a dispenser, a loiter-line, and an aircraft. The dispenser capable of releasing controlled amounts of a fluid. The loiter-line connected to the dispenser and connected to an aircraft, wherein the aircraft can maneuver the dispenser via the loiter-line such that the dispenser is positioned for accurate fluid delivery to a target. The dispenser fluid can be an aerosol, a dispersion, optical taggants, or powder based.

### GOVERNMENT RIGHTS

This invention was made with government support under Contract No. FA8650-13-C-2319 awarded by the United States Air Force Research Laboratory (AFRL). The government has certain rights in this invention.

### TECHNICAL FIELD

The present disclosure relates in general to aerial delivery systems. The disclosure relates in particular to fluidic delivery by aircraft.

### BACKGROUND INFORMATION

Aerial delivery systems are used to carry and dispense materials to desired locations. Aerial delivery systems include cable lines for picking up and delivering materials. One example involves helicopters equipped with a cable to collect or deploy equipment and supplies. A similar example includes having a bucket attached to the cable and dropping the bucket to ground level for delivery or receipt of material.

Conventional fluidic aerial delivery systems allow fluid delivery to areas and objects otherwise impractical to approach by ground. For instance, aircraft deliver fertilizer and pesticides to crops by dispensing fluid at low altitudes. Aircraft deliver water and fire retardant to forest fires both by plane and suspended buckets from helicopters.

The disclosure below relates to another approach.

### SUMMARY OF THE DISCLOSURE

The present disclosure is directed to an aerial fluid delivery system. The aerial fluid delivery system comprises a dispenser, a loiter-line, and an aircraft. The dispenser capable of releasing controlled amounts of a fluid. The loiter-line connected to the dispenser and connected to an aircraft, wherein the aircraft can maneuver the dispenser via the loiter-line such that the dispenser is positioned at about a temporally sustained position for accurate fluid delivery to a target.

The dispenser fluid can be an aerosol, a dispersion, optical taggants, or powder based and can be dispensed directly from the dispenser via an orifice or a nozzle, or otherwise projected by the dispenser. For instance the fluid can be contained within a capsule, the capsule projected from the dispenser, the capsule breaking upon impact with the target. The aircraft can be controlled manually or by an autopilot.

### BRIEF DESCRIPTION OF THE DRAWINGS

The accompanying drawings, which are incorporated in and constitute a part of the specification, illustrate preferred methods and embodiments of the present disclosure. The drawings together with the general description given above and the detailed description of preferred methods and embodiments given below, serve to explain principles of the present disclosure.

FIG. 1 is a perspective view of an aerial fluid delivery system comprising a dispenser, the dispenser capable of releasing controlled amounts of a fluid, a loiter-line, the loiter-line connected to the dispenser and connected to an aircraft, wherein the aircraft can maneuver the dispenser via the loiter-line such that the dispenser is positioned for accurate fluid delivery to a target.

FIG. 2 is a perspective view, schematically illustrating the aerial fluid delivery system performing long loiter-line maneuvering for accurate fluid delivery to a stationary target.

FIG. 3 is a perspective view, schematically illustrating the aerial fluid delivery system maneuvering for accurate fluid delivery to a moving target.

FIG. 4 is a perspective view illustrating the dispenser wherein the dispenser sprays the fluid.

FIG. 5 is a perspective view illustrating the dispenser wherein the dispenser projects encapsulated vessels contains the fluid.

FIG. 6A is a perspective view of the dispenser further comprising a stabilizer fin.

FIG. 6B is a perspective view of the dispenser further comprising a drogue parachute.

### DETAILED DESCRIPTION OF EMBODIMENTS

Referring now to the drawings, wherein like components are designated by like reference numerals. Methods and various embodiments of the present invention are described further hereinbelow.

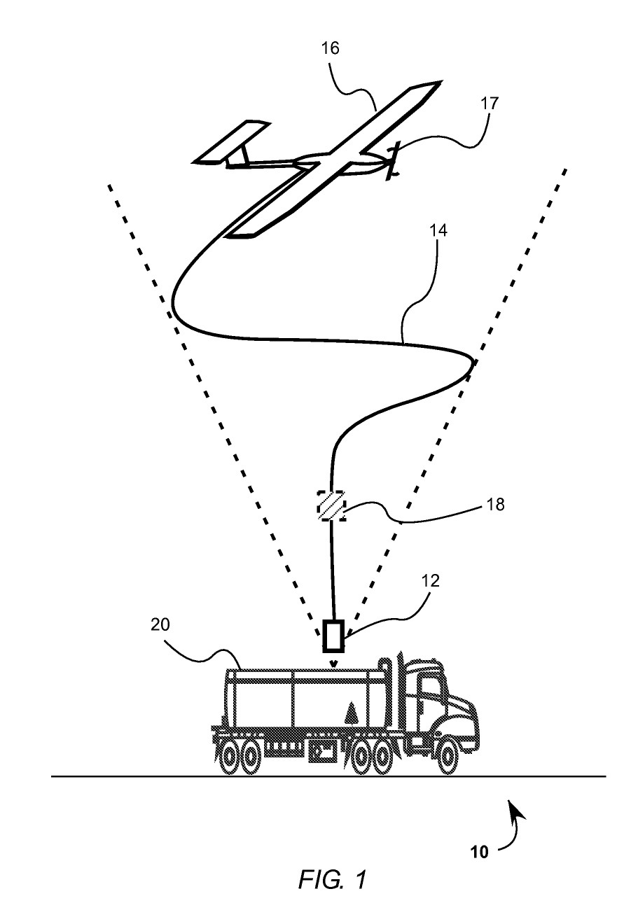

Referring to FIG. 1, an aerial fluid delivery system 10 comprises a dispenser 12, a loiter-line 14, and an aircraft 16. Dispenser 12 capable of releasing controlled amounts of a fluid. Loiter-line 14 connected to dispenser 12 at one end and connected to an aircraft 16 at the other end. Aircraft 16 capable of maneuvering dispenser 12 via loiter-line 14 such that dispenser 12 is positioned for accurate fluid delivery to a target. Here, the target is represented as a truck 20.

Dispenser 12 can contain a variety of fluids for dispensement dependent on the application. Here, the term fluid means any substance, or aggregate of substances that can be dispensed and applied to the target. Nonlimiting examples of fluids are liquids, aerosol, or powder. The dispenser can have an orifice or nozzle for dispensing the fluid. For instance, the fluid can be a liquid, aerosol, or fine powder sprayed from the dispenser. Alternatively the fluids can be contained with a breakable capsule, the capsule projected from the dispenser toward a target, breaking upon impact. The fluid can be or contain a taggant for application to the target. The taggant can be optically identifiable particles, such as nanoparticles, with unique spectral signatures for tracking marked targets. The taggant in general can be something attached to an item to be located and tracked, increasing the ability to identify the item by a surveillance system tuned to the taggant.

For taggant applications, nanoparticle can us used. The nanoparticles can include semiconductor based or quantum dot materials made of core, core-shell, and core-shell ligand architectures. Nonlimiting examples of the nanoparticles useful as taggants include CdSe, PbSe, InSb, CulnSe, CeZnTe, ZnO, ZnSe, YVO4, La Br3, and LaF3. The type and the size of the nanoparticles allows unique spectral signatures of the fluid. Further a plurality of the nanoparticle types can be implemented. Both up-converting and down-converting nanoparticle types can be used.

Dispenser 12 can be connected to loiter-line 14 via a simple mechanical connection, or can be gimbal mounted. The dispenser can include fins, rotors, drogue parachute and of such aerodynamic directional stability features. The dispenser can be equipped with an optical camera, a laser range finder, a GPS module, laser rangefinder (LRF), an anemometer, and other such metrology equipment.

Loiter-line 14 can be made from a monofilament, braided filament, and other such cabling, the size of cabling dependent on the weight of the dispenser and particular application. For instance, the dispensers for pesticide application may require the loiter-line to can handle a heavier payload. Similarly, a dispenser for tagging a target may need to be more discrete and require the loiter-line to a lightweight monofilament or a lightweight braided filament. The loiter-line can include electrical or optical communication lines to allow communication between the aircraft and the dispenser.

The loiter-line can optionally include a mass 18 between the dispenser and the aircraft. The mass can provide stability to the dispenser. The mass can also house additional fluid reservoirs, electrical control equipment, communication equipment, metrology equipment, and other such apparatus.

The loiter-line is connected to the aircraft. The connection can be a simple mechanical connection such as a hook, or can be an actuated reel or winch. The reel be housed within the aircraft allowing the dispenser to be carried within the aircraft until required deployment. The reel can lower and raise the dispenser for accurate dispensement. The retractable reel or winch can include a breaking system, a line-cutter, and a clutch to accommodate fast dispenser retraction and deployment.

The aircraft can be a conventional airplane, piloted directly onboard or an unmanned aerial vehicle (UAV) piloted remotely. Here, aircraft 16 is a rotor 17 based airplane. The aircraft can be a helicopter or UAV quadcopter. The aircraft can have an autopilot or an autopilot-mode. The autopilot maneuvering the aircraft such the dispenser is positioned for accurate fluid delivery to the target. The autopilot can be engaged after identification of the target by the autopilot, or the autopilot can both identify the target and begin the approach and control maneuvering or orbiting patterns for delivery to the target.

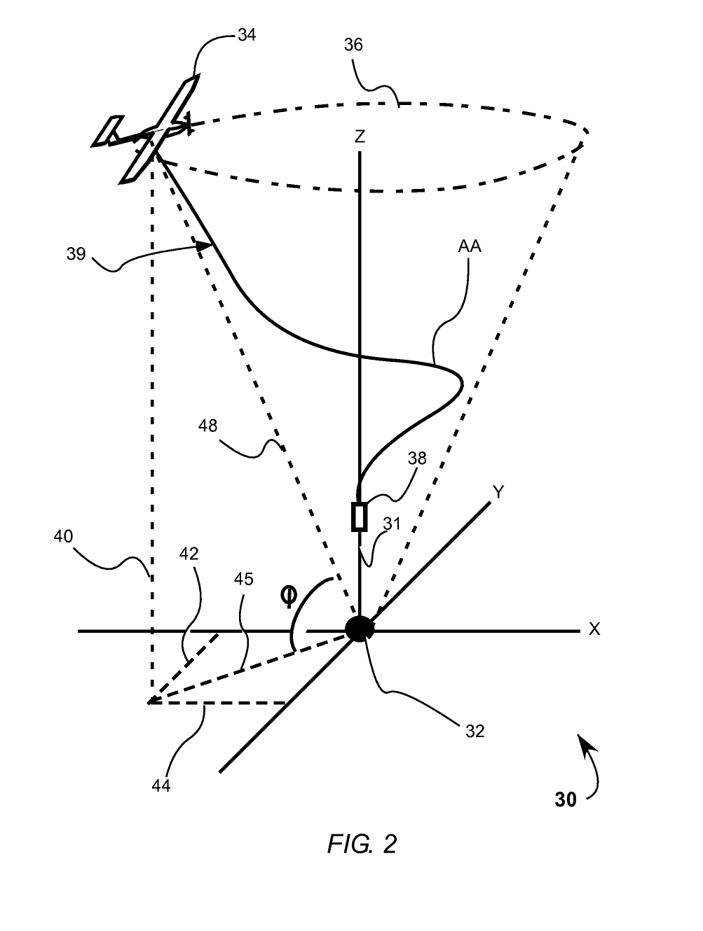

FIG. 2 is a schematic illustration 30 of a flight pattern for delivery of a fluid 31 to a stationary target 32. Here a UAV 34 maneuvers in a circular orbit 36 about stationary target 32. UAV 34 maneuvers in circular orbit 36 about target 32 holding a pylon turn around target 32 such that a dispenser 38, suspended by a loiter-line 39, is about a temporally sustained position with respect to target 32 for fluid 31 delivery. Techniques that allow for suspended payloads from aircraft are generally referred to as long-line loitering techniques. In order to determine the required orbital pattern, a pilot or preferably an autopilot continuously determines the target location with respect to the aircraft and adjust the circular orbit as necessary. For reference, target 32 resides on an X-Y plane. UAV 34 is shown at a height 40 relative to target 32. An orbital radius 45 of circular orbit 36 is defined by an X-vector coordinate 44 and a Y-vector coordinate 42 and with respect to target 32. An azimuth angle φ is the angle between target 32 and aircraft 34 with respect to the X-Y plane. To determine the appropriate azimuth angle for the circular orbit a variety of factor must be considered in a multiphysics problem.

Orbit radius 36 will depend on a variety of factors. Such factors for positioning the dispenser with respect to the target include, the weight and size of the dispenser, the dispenser fluid, the dispensing mechanism and dispenser flow, the proximity of the target to the dispenser, the amount of fluid to be delivered to the target, the target surface area and size, the targets trajectory if any, the weight, rigidity, the height of the aircraft, the release rate of the loiter-line, the length of the loiter-line, the drag of the loiter-line, and environmental factors such as humidity, rain, and wind or crosswinds. The aircraft can be manually piloted or can be controlled by an autopilot.

The dispenser is in a temporally sustained position when the dispenser is position in proximity to the target for sufficient time to dispense the required amount of fluid for the particular application. For instance, a stationary target or a target that requires a greater amount of fluid may require the dispenser to be positioned with respect to the target for a longer period of time. If the dispensement mechanism and type of fluid allow for quick dispensement, the dispenser may be in motion, the moving dispenser dispensing fluid at an appropriate position with respect to the target for the fluid to intercept and apply to the target.

To deliver fluid to a moving target, the aircraft can approach the vehicle, match the vehicle speed, and adjust altitude or the loiter-line length so that the dispenser is positioned at a temporally sustained position with respect to the target for accurate fluid delivery. If the application requires a faster or more discrete fluid delivery, the aircraft can maneuver the dispenser by sweeping the dispenser so that the dispenser trajectory is about the same as the target trajectory and in proximity with the target for at least sufficient time for accurate fluid delivery. Such maneuvering allows the aircraft to travel at a different velocity, direction, or both with respect to the target.

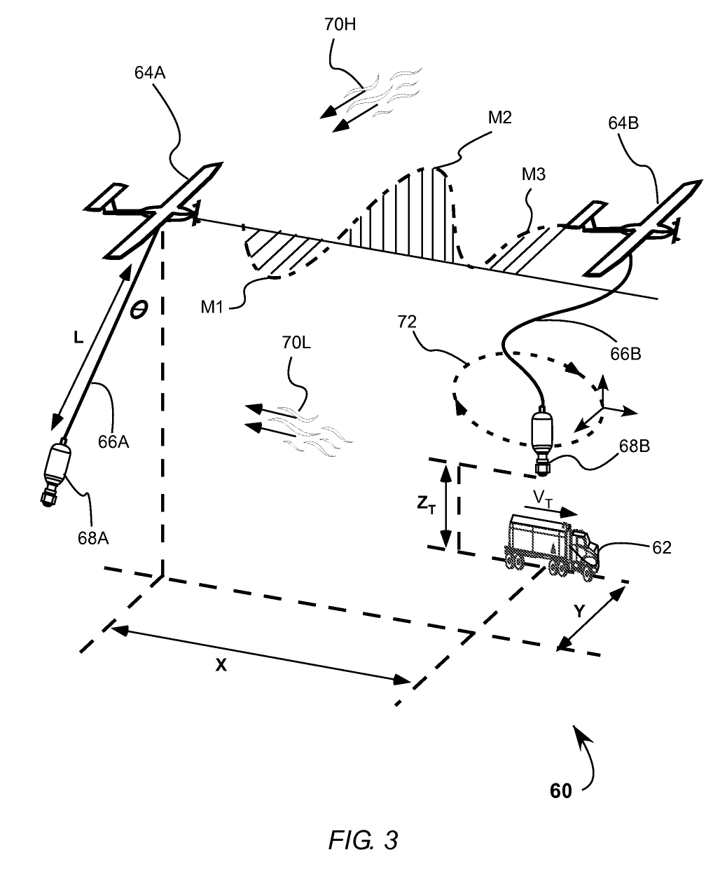

Referring to FIG. 3 a schematic 60 illustrates the aerial dispensing system applying the fluid to a moving target 62. Here, moving target 62 is truck traveling a velocity V_{T}. Initially, an aircraft 64A travels towards the truck in a straight path, with a dispenser 68A suspended by a loiter-line 66A both the aircraft and the dispenser traveling at the same velocity. When the aircraft is traveling in a straight path the dispenser is suspended and lagging behind the aircraft at an angle θ with the respect to a vertical Z-axis. By way of example, the pilot or autopilot recognizes the target. Similar to the long-line orbital technique, the pilot or autopilot determines the appropriate flight path based on the aforementioned factors. For instance, taking into account both high altitude wind 70H and low altitude wind 70L. The aircraft maneuvers M1 horizontally banking right then left in the X-Y plane sweeping the dispenser starboard. The aircraft then maneuvers M2 vertically up and down causing the dispenser to travel in a tilted orbital path 72 about the aircraft. The aircraft then maneuvers M3 banking left and right such that for at least a portion of the arc of the tilted orbital path, the dispenser 68B at an altitude Z_{T}, in close proximity to target 62, and traveling at about velocity V_{T}, velocity V_{T} slower than the aircraft velocity, to dispense fluid onto the target.

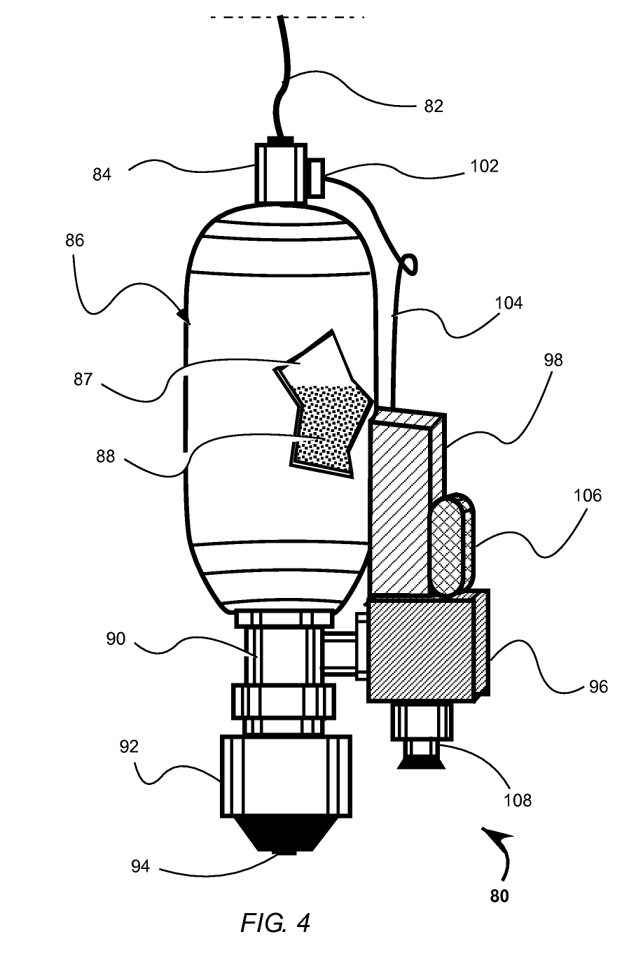

Referring to FIG. 4, a representative spraying dispenser 80 for fluid delivery. Dispenser 80 is connected to a loiter-line 82 via a swivel mount 84. A high pressure tank 86 has a fluid 88 and a high pressurized gas 87. Here, the fluid is forced out by the high pressure gas, alternative embodiments can have separate pressurized tanks for dispensement of the fluid. High pressure tank 86 is connected to a solenoid valve 90. Opening solenoid valve 90 allows dispensement of fluid 88. Solenoid valve 90 is connected to a spray nozzle 92 to direct fluid out through an opening 94. Opening 94 can be sized for fluid dispensement in a stream or a wider atomized spray pattern dependent on the spray rate and type of fluid. The nozzle opening can incorporate various designs such as plan-orifice, shaped-orifice, surface impinging, spiral impinging, recirculating, and passive and active atomizers. Here, one nozzle is shown, in other embodiments a plurality of nozzles can be incorporated to provide concentrated or wider spray patterns. Further each nozzle can be or incorporate compound

A microcontroller unit 98 controls the dispenser and operates a solenoid controller 96, which opens and closes solenoid 90. Here, the dispenser has an infrared (IR) light-emitting diode (LED) transceiver 102, the transceiver in connection with microcontroller board by a communication cable 104. IR-LED transceiver 102 allows communication between the dispenser and the aircraft. Alternatively an optical fiber can be routed along the loiter-line, or be the loiter-line, to allow communication between the dispenser and aircraft. A battery 106 powers the microcontroller unit and all apparatus on the dispenser.

The dispenser has an optical camera 108, the optical camera providing targeting and positioning data to the microcontroller. If transmitted to the aircraft, an operator can release fluid based on the imagery. With machine vision software the fluid can be released based on preprogrammed image information. Alternatively or in addition to an optical camera, the dispenser can be equipped with an ultrasonic range finder. The ultrasonic rangefinder allows fluid dispensement to be triggered based on proximity to a target and can allow fluid release without any communication required to and from the aircraft.

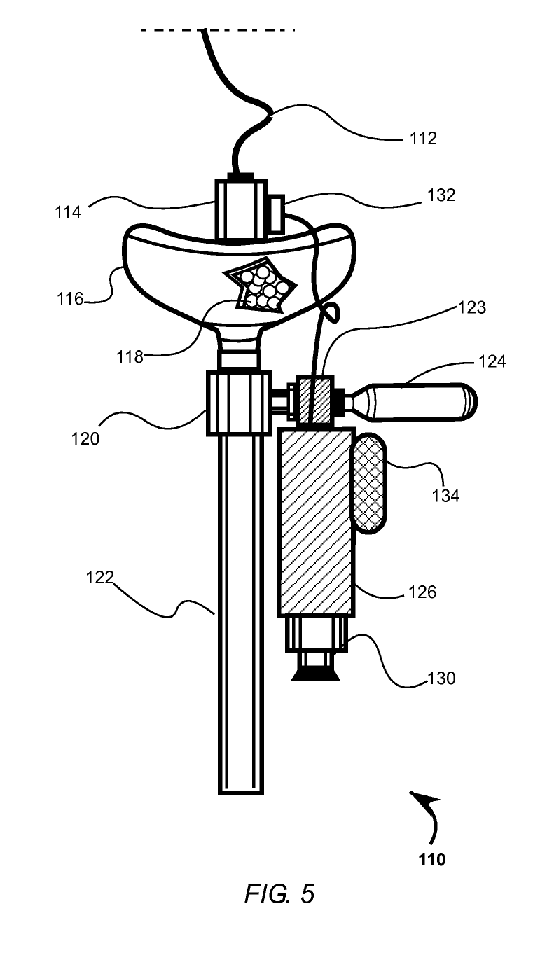

Referring to FIG. 5, a representative projectile dispenser 110. Projectile dispenser 110 has apparatus similar to the dispenser that shown in FIG. 4, except here, the projectile dispenser allows fluid delivery by projecting a fluid encapsulated breakable vessel 118. Dispenser 110 is connected to a loiter-line 112 via a swivel mount 114. A reservoir 116 has a plurality of the encapsulated breakable vessels 118.

Projectile dispenser 110 operates similar to a paintball gun. Reservoir 116 is in connection with a chamber 120. Chamber 120 receives at least one of the vessels. Chamber 120 leads to a barrel 122 and the chamber is connected with a pressurized source via a regulator 123. Here, the pressurized source is a CO2 cartridge 124. Upon firing, chamber 120 is isolated from the reservoir and receives a burst of pressurized gas, projecting the vessels down the barrel and towards the target. Similar to that shown in FIG. 4, the projectile dispenser has a microcontroller unit 126, the microcontroller unit controlling regulator 124, an optical camera 130, and a transceiver 132. A battery 134 powers the microcontroller unit and all apparatus on the dispenser.

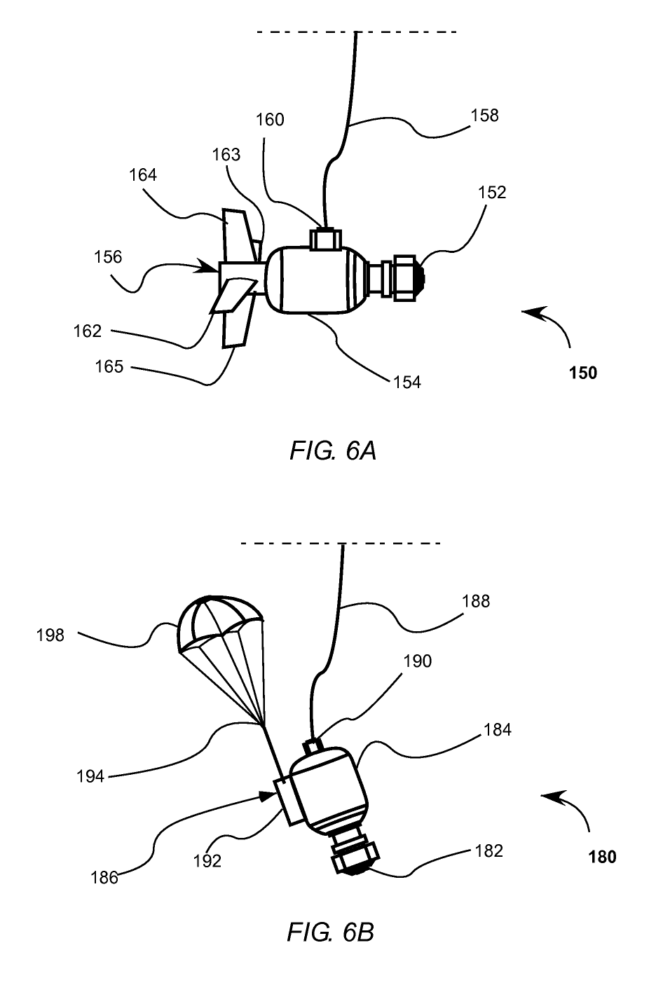

FIG. 6A is a perspective view of an aerial fluid dispenser 150. Aerial dispenser 150 has a nozzle 152, a reservoir 154, and a stabilizer 156. The aerial dispenser is connected to a loiter line 158 via mechanical connection 160. Here, stabilizer 160 includes a horizontal stabilizing fin 162 and horizontal fin 163, and a vertical stabilizer fin 164 and a stabilizer fin 165, the fins symmetrically positioned to ensure directional stability of the dispenser. The stabilizer allows for controlled positioning of the dispenser with respect to the target.

FIG. 6B is a perspective view of a dispenser 180. Aerial dispenser 180 has a nozzle 182, a reservoir 184, and a drogue pack 186. The aerial dispenser is connected to a loiter line 188 via mechanical connection 190. Drogue pack 186 contains a retractable parachute line 194 and a drogue parachute 198. The drogue parachute can be used to directionally position the dispenser.

The present embodiments and methods described in the present disclosure invention have a variety of useful applications. For instance, the aerial deliverer system can be utilized in any application requiring accurate fluid delivery. Applications include those in agriculture, forestry, and military. In particular, the aerial fluid delivery system is useful for discrete tagging.

From the description of the present disclosure provided herein one skilled in the art can manufacture the apparatus and practice the methods disclosed in accordance with the present disclosure. While the present invention has been described in terms of particular embodiments and examples, others can be implemented without departing from the scope of the present invention. In summary, the present disclosure above describes particular embodiments. The invention, however, is not limited to the embodiments described and depicted herein. Rather, the invention is limited only by the claims appended hereto.

What is claimed is:

1. An aerial fluid delivery system comprising:
a dispenser, the dispenser capable of releasing controlled amounts of a fluid;
a loiter-line, the loiter-line connected to the dispenser and connected to an aircraft; and
wherein the aircraft can maneuver the dispenser via the loiter-line such that the dispenser is positioned for accurate fluid delivery to a target.

2. The aerial fluid delivery system of claim 1, wherein the aircraft is an unmanned aerial vehicle (UAV).

3. The aerial fluid delivery system of claim 1, wherein the aircraft has an autopilot, the autopilot maneuvering the aircraft such that the dispenser has orbital pattern, where the orbit positions the dispenser at about a temporally sustained position relative to the target for accurate fluid delivery to the target.

4. The aerial fluid delivery system of claim 1, wherein the target is in motion.

5. The aerial fluid delivery system of claim 1, wherein the aircraft trajectory is controlled to compensate wind.

6. The aerial fluid delivery system of claim 1, wherein the target is airborne.

7. The aerial fluid delivery system of claim 1, wherein the dispenser is in communication with the aircraft.

8. The aerial fluid delivery system of claim 7, wherein communications is wireless.

9. The aerial fluid delivery system of claim 1, wherein the loiter-line is retractable.

10. The aerial fluid delivery system of claim 1, wherein the retractable loiter-line has a clutch.

11. The aerial fluid delivery system of claim 1, further comprising a base station, the base station in wireless communication to the aircraft and in wireless communication to the dispenser.

12. The aerial fluid delivery system of claim 1, wherein the fluid is delivered in the form of an encapsulated vessel, the encapsulated vessel breaking upon impact.

13. The aerial fluid delivery system of claim 1, wherein the fluid comprises of a taggant, the taggant having remotely identifiable optical properties.

14. The aerial fluid delivery system of claim 13, wherein the taggant are defined with a unique spectral signature.

15. The aerial fluid delivery system of claim 1, wherein the dispenser has a fins, the fins providing aerodynamic directional stability.

16. The aerial fluid delivery system of claim 1, wherein the dispenser is equipped with an optical camera, a laser range finder, a GPS module, an anemometer, or a gimbal mount and combinations thereof.

17. The aerial fluid delivery system of claim 1, wherein the loiter-line has a mass between the dispenser and the aircraft.

18. The aerial fluid delivery system of claim 17, wherein the mass has fins, the fins providing aerodynamic directional stability.

19. A method of delivering fluid to a target, the steps comprising:
providing a dispenser, the dispenser capable of releasing controlled amounts of a fluid, the dispenser connected to a loiter-line, the loiter-line connected to an aircraft;
indicating a target for receipt of the fluid;
maneuvering the aircraft such that the dispenser is in a position to accurately dispense the controlled amount of the fluid onto the target; and
dispensing the fluid such that the target receives application of the fluid.

20. The method of claim 19, further comprising the step of lowering the dispenser via a cabling system.

21. The method of claim 19, wherein the aircraft maneuvers in an orbit around a stationary object to temporally sustain the position of the dispenser with respect to the target.

22. The method of claim 19, wherein the aircraft maneuvers causes the dispenser to orbit about the aircraft such that the dispenser position is temporally sustained with respect to the target.

23. The method of claim 19, wherein the target is moving.
